(19) United States
(12) Patent Application Publication
(10) Pub. No.: US 2014/0121992 A1
(43) Pub. Date: May 1, 2014

(54) SYSTEM AND METHOD FOR ALIGNING GENOME SEQUENCE

(71) Applicant: SAMSUNG SDS CO., LTD., Seoul (KR)

(72) Inventor: Minseo PARK, Seoul (KR)

(73) Assignee: SAMSUNG SDS CO., LTD., Seoul (KR)

(21) Appl. No.: 13/972,233

(22) Filed: Aug. 21, 2013

(30) Foreign Application Priority Data
Oct. 29, 2012 (KR) 10-2012-0120447

(51) Int. Cl. G06F 19/22

(52) U.S. Cl. CPC G06F 19/22
USPC 702/20

(57) ABSTRACT

A system and a method for aligning genome sequence are provided. The system for aligning genome sequence includes a mapping position calculation unit configured to select one of a plurality of seeds produced from a read and calculate a mapping position of the selected seed in a target sequence, and a global alignment unit configured to calculate a repeat judgment region for the selected seed from the calculated mapping position, determine whether global alignment is pre-performed in the calculated repeat judgment region and perform global alignment the selected read at the calculated mapping position when the global alignment is not pre-performed.

### CROSS-REFERENCE TO RELATED APPLICATION

This application claims priority to and the benefit of Republic of Korea Patent Application No. 10-2012-0120447, filed on Oct. 29, 2012, the disclosure of which is incorporated herein by reference in its entirety.

### BACKGROUND

1. Field

The present disclosure relates to technology for analyzing a genome sequence.

2. Discussion of Related Art

A next-generation sequencing (NGS) method of producing a large amount of short sequences is rapidly replacing the conventional Sanger's sequencing method due to its inexpensive cost and rapid data generation. Also, various programs for aligning an NGS sequence have developed with a focus on accuracy. However, a cost required to construct a fragment sequence has been reduced to less than half the cost required in the past with current developments in next-generation sequencing technology. As a result, as a quantity of the data is increasingly used, technology for rapidly and accurately processing a large amount of short sequences is required.

The first operation of aligning a sequence is to map a read at an exact position of a reference sequence using an algorithm for aligning a genome sequence. In this case, it is problematic that there are differences in genomes sequence due to the presence of various genetic variations even among subjects of the same species. Also, differences in genome sequences may be caused due to errors in a sequencing process. Therefore, the algorithm for aligning a genome sequence has to effectively enhance mapping accuracy in consideration of the differences in genome sequences and the genetic variations.

In conclusion, as much data on the entire genomic information as possible is required so as to analyze the genomic information. For this purpose, development of an algorithm for aligning a genome sequence, which has excellent accuracy and high throughput, should also be achieved in advance. However, the conventional methods have limits in satisfying these requirements.

### SUMMARY

The present disclosure is directed to a means for aligning a genome sequence capable of ensuring mapping accuracy and simultaneously improving complexity upon mapping to increase a processing rate.

According to an aspect of the present disclosure, there is provided a system for aligning a genome sequence, which includes a mapping position calculation unit configured to select one of a plurality of seeds produced from a read and calculate a mapping position of the selected seed in a target sequence, and a global alignment unit configured to calculate a repeat judgment region for the selected seed from the calculated mapping position, determine whether global alignment is pre-performed in the calculated repeat judgment region and perform global alignment on the selected read at the calculated mapping position when the global alignment s not pre-performed.

According to another aspect of the present disclosure, there is provided a method of aligning a genome sequence, which includes selecting one of a plurality of seeds produced from a read and calculate a mapping position of the selected seed in a target sequence at a mapping position calculation unit, calculating a repeat judgment region for the selected seed from the calculated mapping position at a global alignment unit, and determining whether global alignment is pre-performed in the calculated repeat judgment region and performing global alignment on the selected read at the calculated mapping position when the global alignment is not pre-performed at the global alignment unit.

According to still another aspect of the present disclosure, there is provided a device including one or more processors, a memory, and one or more programs. Here, the one or more programs are configured to be stored in the memory and executed by the one or more processors, and the program includes commands to execute the following operations: selecting one of a plurality of seeds produced from a read and calculating a mapping position of the selected seed in a target sequence, calculating a repeat judgment region for the selected seed from the calculated mapping position, and determining whether global alignment is pre-performed in the calculated repeat judgment region and performing global alignment on the selected read at the calculated mapping position when the global alignment is not pre-performed.

### BRIEF DESCRIPTION OF THE DRAWINGS

The above and other objects, features and advantages of the present disclosure become more apparent to those of ordinary skill in the art by describing in detail exemplary embodiments thereof with reference to the accompanying drawings, in which:

FIG. 1 is a diagram explaining a method of aligning a genome sequence according to one exemplary embodiment of the present disclosure;

FIG. 2 is a diagram exemplifying a process of calculating a mismatch in the method of aligning a genome sequence according to one exemplary embodiment of the present disclosure;

FIG. 3 is a flowchart illustrating a process of performing global alignment according to one exemplary embodiment of the present disclosure;

FIGS. 4A to 4E are diagrams showing one example of the process of performing global alignment according to one exemplary embodiment of the present disclosure; and

FIG. 5 is a block diagram showing a system for aligning a genome sequence according to one exemplary embodiment of the present disclosure.

### DETAILED DESCRIPTION OF EXEMPLARY EMBODIMENTS

Exemplary embodiments of the present disclosure will be described in detail below with reference to the accompanying drawings. While the present disclosure is shown and described in connection with exemplary embodiments thereof, it will be apparent to those skilled in the art that various modifications can be made without departing from the scope of the present disclosure.

Also, descriptions of well-known functions and constructions may be omitted for increased clarity and conciseness. In addition, terms described below are terms defined in consideration of functions in the present disclosure and may be changed according to the intention of a user or an operator or conventional practice. Therefore, the definitions must be based on content throughout this disclosure.

Also, descriptions of well-known functions and constructions may be omitted for increased clarity and conciseness. In addition, terms described below are terms defined in consideration of functions in the present disclosure and may be changed according to the intention of a user or an operator or conventional practice. Therefore, the definitions must be based on content throughout this disclosure.

Prior to describing the exemplary embodiments of the present disclosure in detail, first, the terminology used herein will be described in advance, as follows.

First, the term “read” refers to genome sequence data having a short length, which is output from a genome sequencer. Reads generally vary in length ranging from approximately 35 to 500 bp (base pairs) according to the kind of a genome sequencer. In general, DNA bases are represented by four characters: A, C, G, and T.

The term “target genome sequence” refers to a genome sequence (a reference sequence) used for reference to produce a full-length genome sequence from the reads. In analysis of the genome sequence, a large amount of reads output from a genome sequencer are mapped to a target genome sequence to complete the full-length genome sequence. According to the present disclosure, the target genome sequence may be a sequence (for example, a full-length human genome sequence, etc.) set in advance upon analysis of a genome sequence, or a genome sequence synthesized in a genome sequencer may also be used as the target genome sequence.

The term “base” refers to a basic unit constituting a target genome sequence and a read. As described above, the DNA bases may include four letters: A, C, G, and T, each of which is referred to as a base. That is, the DNA bases are represented by four bases. Also, this is applicable to the reads in like manner.

The term “seed” refers to a sequence which is a basic unit used when a read is compared with a target genome sequence so as to map the read. In theory, mapping positions of reads should be calculated while sequentially comparing the entire read with the target genome sequence beginning from the 1^{st} base of the target genome sequence so as to map the read to the target genome sequence. However, such a method has a problem in that large amounts of time and computing power are required to map one read. Therefore, a seed that is a piece that is actually composed of a portion of the read is first mapped to the target genome sequence to search for a mapping candidate position of the entire read and map the entire read at a corresponding candidate position (global alignment).

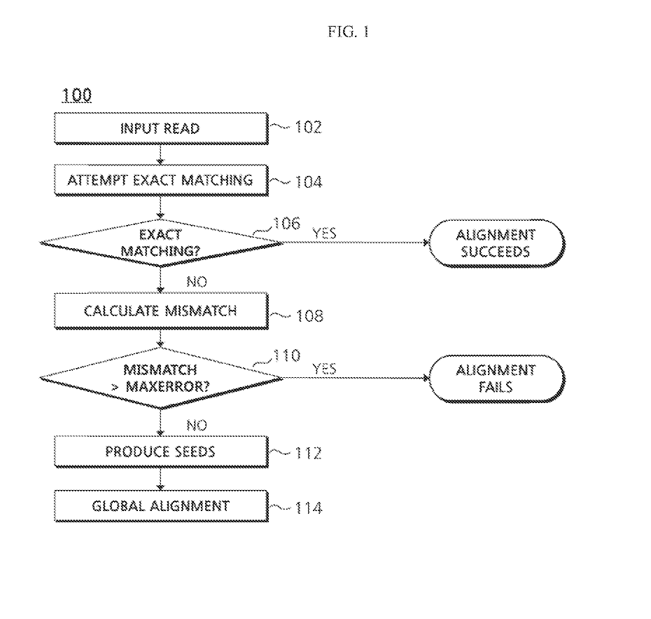

FIG. 1 is a diagram explaining a method 100 of aligning a genome sequence according to one exemplary embodiment of the present disclosure. According to this exemplary embodiment of the present disclosure, the method 100 of aligning a genome sequence refers to a series of processes including comparing reads output from a genome sequencer with a target genome sequence and determining a mapping (or aligning) position of the read on the target genome sequence so as to construct the entire sequence.

First, when reads are gotten from a genome sequencer (Operation 102), exact matching of the entire read with the target genome sequence is attempted (Operation 104). From the results of this attempt, when the exact matching of the entire read succeeds, the alignment is determined to have succeeded without performing alignment operation (Operation 106).

From the results of experiments on human genome sequences, when 1,000,000 reads output from a genome sequencer are exactly matched with the human genome sequences, 231,564 cycles of the exact matching appear to take place in a total of 2,000,000 alignments (1,000,000 alignments for a forward sequence, and 1,000,000 alignments for a reverse complementary sequence) on assumption that each read has a length of 755 bp. Therefore, the results obtained in Operation 104 show that a work load required for the alignments may be reduced by approximately 11.6%.

On the other hand, when the corresponding read is determined not to be exactly matched in Operation 106, a mismatch, which may occur when the corresponding read is aligned on the target sequence, is calculated (Operation 108).

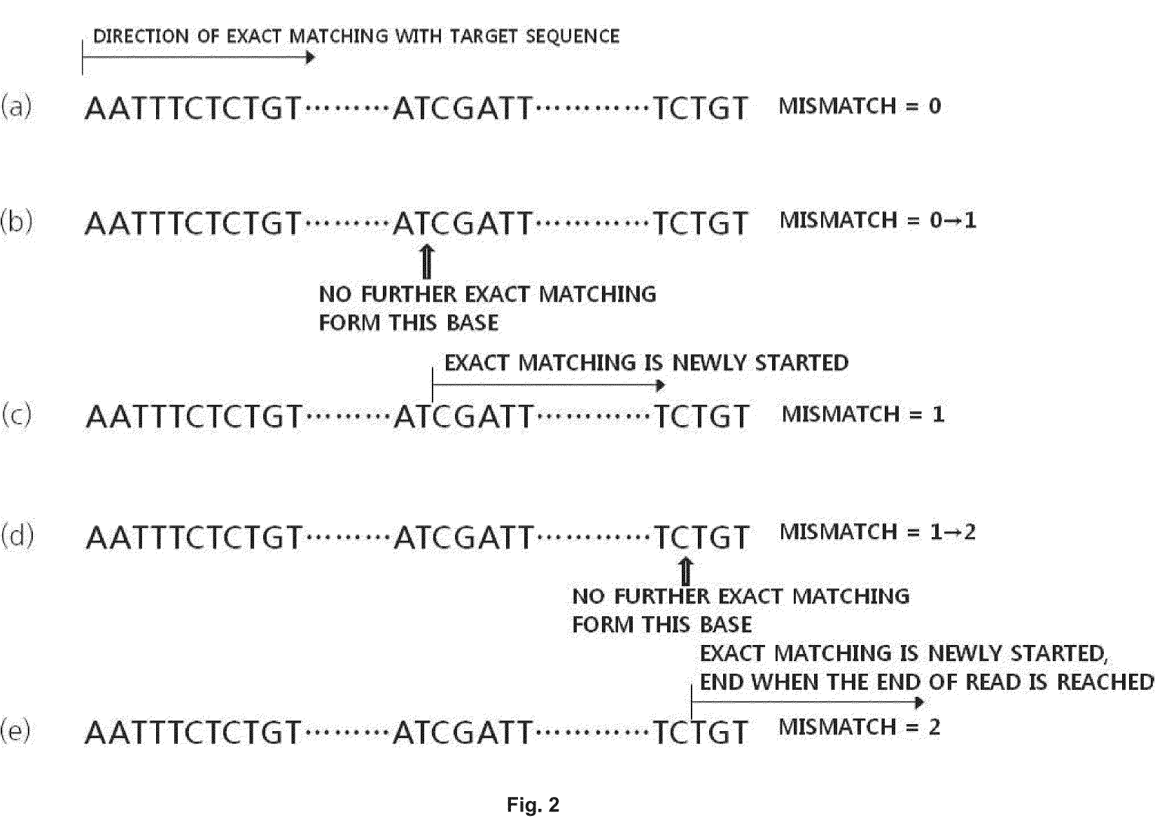

FIG. 2 is a diagram exemplifying a process of calculating a mismatch in Operation 108. As shown in FIG. 2A, an initial mismatch value is first set to 0 (mismatch=0), and exact matching is attempted while migrating from a 1^{st} base of a read one by one in a right direction. In this case, if it is assumed that further exact matching from a certain base (a base indicated by an arrow) of the read is impossible to perform as shown in FIG. 2B, this means that an error takes place somewhere in a section spanning from a matching start position to a current position of the read. Therefore, the mismatch value is increased by one accordingly ((mismatch=0→1), and new exact matching starts at the next position (indicated by (c) in the drawing). Next, when the exact matching is determined to be impossible to perform again, another error takes place somewhere in another section spanning from a position at which the exact matching re-starts to a current position. As a result, the mismatch value is increased again by one (mismatch=1→2), and new exact matching starts at the next position (indicated by (d) in the drawing). The mismatch value when the end of the read is reached through such a process becomes a mismatch value that may occur in the corresponding read. That is, according to the exemplary embodiment shown in FIG. 2, the read has a mismatch value of 2.

When the mismatch value of the read is calculated through such a process, it is determined whether the calculated mismatch value exceeds a predetermined maximum error allowable value (maxError) (Operation 110). When the calculated mismatch value exceeds the maximum error allowable value, alignment of the corresponding read is determined to have failed, and the alignment is then terminated.

In the above-described experiments on the human genome sequences, when the mismatch values of the other reads are calculated on the assumption that the maximum error allowable value (maxError) is set to 3, it is shown that the mismatch values of the reads corresponding to a total of 844,891 cycles exceed the maximum error allowable value. That is, the results obtained in Operation 108 show that a work load required for the alignments may be reduced by approximately 42.2%.

On the other hand, when the results of the judgment in Operation 110 show that the calculated mismatch values are less than or equal to the maximum error allowable value, alignment on the corresponding read is performed as follows.

First, a plurality of seeds are produced from the read (Operation 112), and global alignment on the read using the plurality of produced seeds is performed (Operation 114). In this case, when the results of the global alignment show that the mismatch value of the read exceeds a predetermined maximum error allowable value (maxError), the alignment is determined to have failed, and the alignment is determined to have succeeded when the mismatch value of the read does not exceed the predetermined error allowable value (Operation 120).

Hereinafter, specific processes including Operations 112 to 114 will be described in detail.

Producing a Plurality of Seeds from Read (Operation 112)

This operation is in earnest to produce seeds which are a plurality of small pieces from a read so as to perform alignment of the read. In this operation, a plurality of seeds are produced in consideration of some or all of the read. For example, the seeds may be produced by dividing all of the read or a certain section of the read into a plurality of piece or combining the divided pieces. In this case, the produced seeds may be sequentially ligated to each other, but the present disclosure is not limited thereto. For example, it is possible to constitute the seeds as a combination of pieces spaced apart from each other in the read. Also, the produced seeds do not necessarily have the same length, and thus it is possible to produce seeds having various lengths in one read. In the present disclosure, for example, a method of producing seeds from a read is not particularly limited. For example, various algorithms of extracting seeds from some or all of the read may be used without limitation.

Performing Global Alignment (Operation 114)

When the seeds are produced through such a process, global alignment on the read with respect to the target sequence is performed using the produced seeds. More particularly, the seeds produced in Operation 112 are used in this operation to map the read to the target sequence by sequentially performing global alignment on the respective seeds at the mapping position in the target sequence.

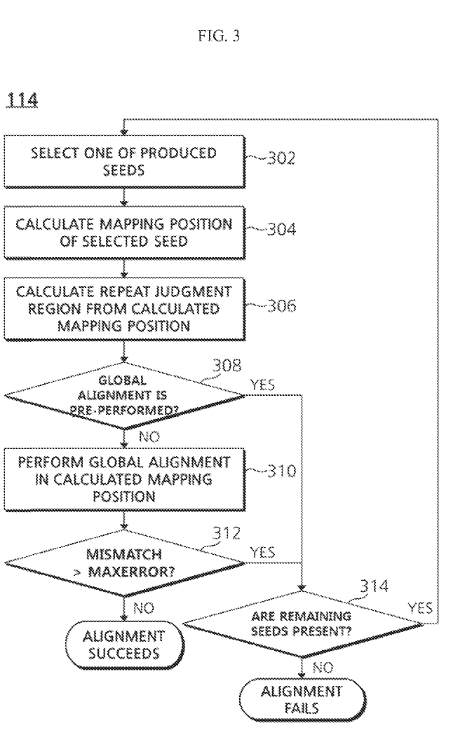

FIG. 3 is a flowchart illustrating a process 114 of performing global alignment according to one exemplary embodiment of the present disclosure. First, one of a plurality of seeds produced front a read is selected (Operation 302), and a mapping position of the selected seed in the target sequence is calculated (Operation 304). According to the exemplary embodiments of the present disclosure, when the term “mapping position” of a seed is simply described without particular limitation, the term refers to a position of a target sequence corresponding to a 1^{st} base of the corresponding seed, and the term “k^{th} mapping position” of a seed refers to a position of the target sequence corresponding to a k^{th} base of the corresponding seed.

Next, a repeat judgment region for the selected seed from the calculated mapping position is calculated (Operation 306). For example, the repeat judgment region may be set as a region to which a difference in distance from a k^{th} mapping position (1≦k≦N, wherein N represents a length of the selected seed) of the selected seed in the target sequence is within a reference value.

Also, the repeat judgment region may be calculated by the following Expression 1.

ma−V≦repeat judgment region≦mb+V Expression 1

In Expression 1, ma represents an a^{th} mapping position (1≦a≦N) of the selected seed, mb represents a b^{th} mapping position (1≦b≦N) of the selected seed, N represents a length of the selected seed, and V represents a reference value.

When the repeat judgment region is calculated using the above-described method, it is determined whether global alignment is pre-performed in the calculated repeat judgment region (Operation 308). In this case, whether the global alignment is pre-performed in the repeat judgment region may be determined from whether the mapping position upon the global alignment in the previous operation (that is, a 1^{st} mapping position of a seed in which global alignment is performed) is included in the repeat judgment region. When the judgment results show that the global alignment is performed in the repeat judgment region, global alignment on the seed selected in Operation 302 is not performed. In this case, it is determined whether there are the seeds on which the global alignment is not still performed among the produced seeds (Operation 314). When there are the seeds on which the global alignment is not still performed, the above-described processes are repeatedly performed on a newly selected seed of the remaining seeds back to Operation 302. In this case, when the judgment results obtained in Operation 314 show that there are no remaining seeds, the alignment on the read is determined to have failed.

Meanwhile, when the judgment results obtained in Operation 308 show that the global alignment is not performed in the corresponding region, global alignment on the read at the calculated mapping position is performed (Operation 310) to determine whether the calculated mismatch value exceeds a predetermined maximum error allowable value (Operation 312). When the judgment results obtained in Operation 312 show that the mismatch in the corresponding mapping position falls within the maximum error allowable value, the alignment on the read is determined to have succeeded. However, when the mismatch exceeds the maximum error allowable value, it is determined whether there is no seed on which the global alignment is subsequently performed (Operation 314). Where there are seeds on which the global alignment is performed, the above-described processes are repeatedly performed on a newly selected seed of the remaining seeds back to Operation 302. In this case, when the judgment results obtained in Operation 314 show that there are no remaining seeds, the alignment on the read is determined to have failed.

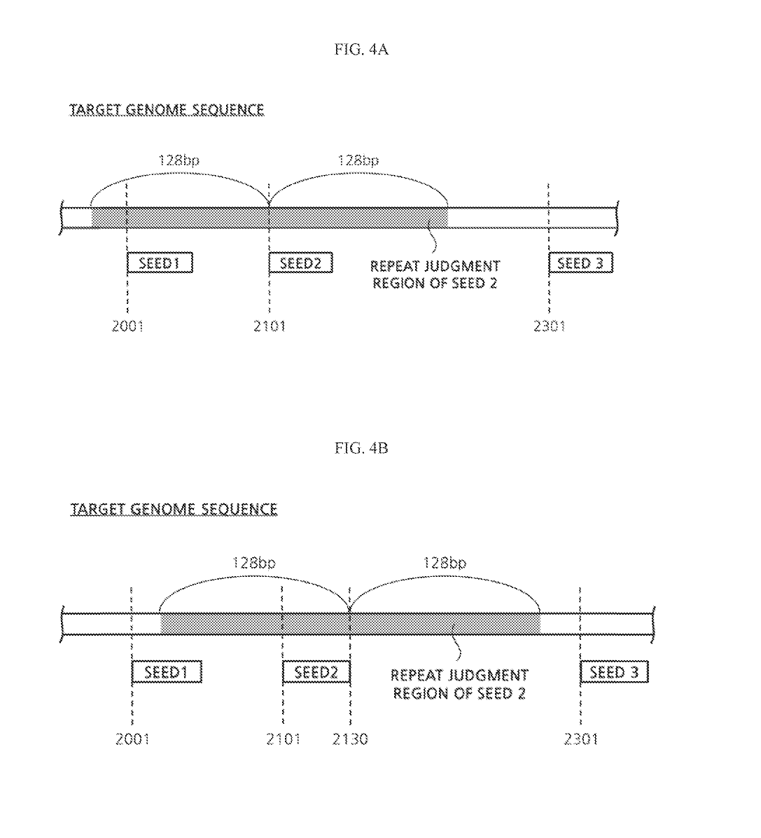

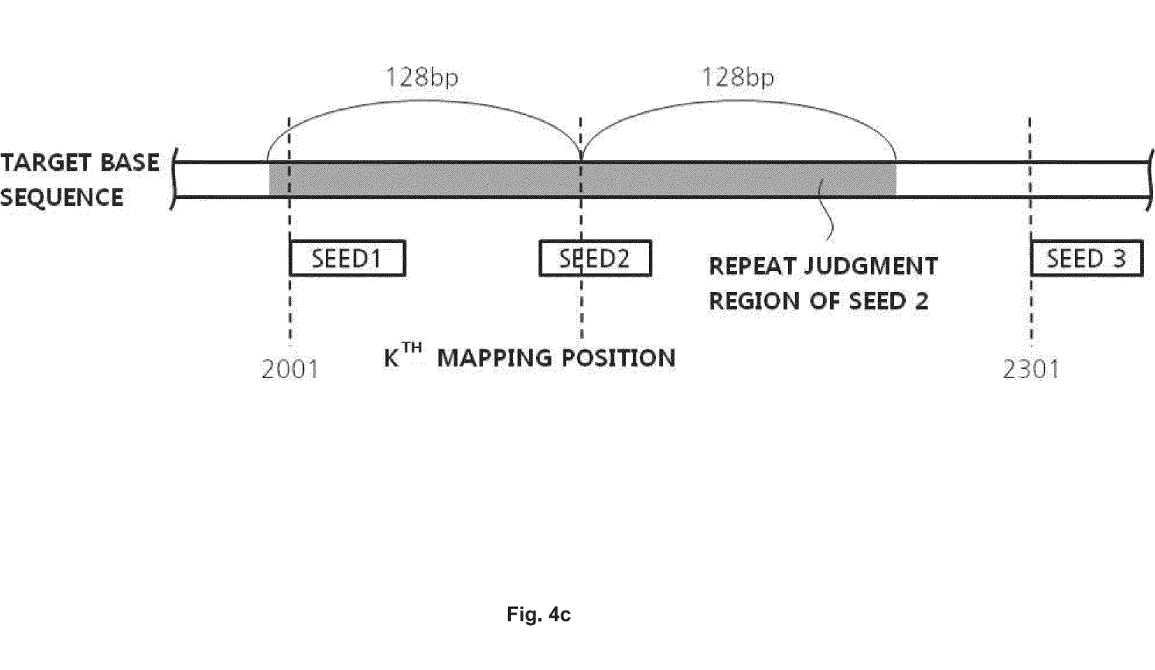

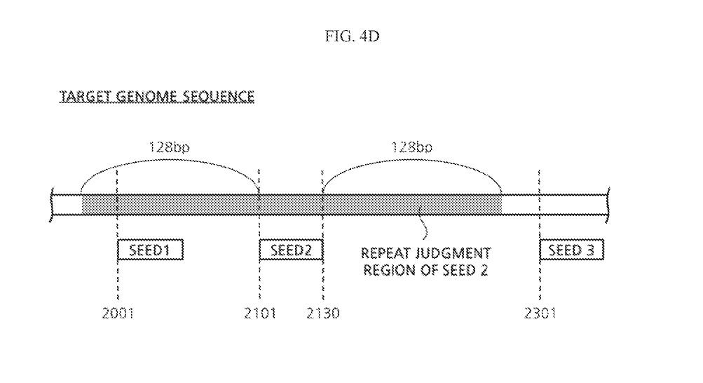

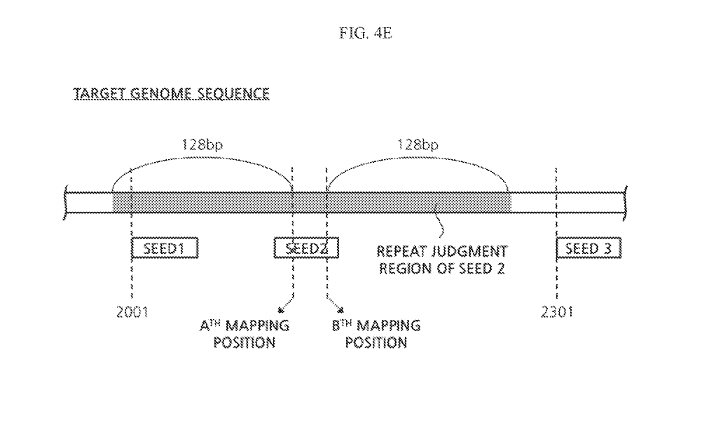

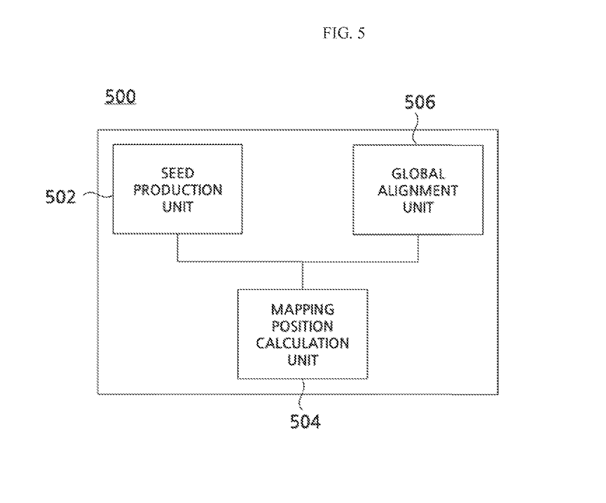

The above-described Operations 306 and 308 will be described as shown in FIGS. 4A through 4E. According to the exemplary embodiment shown in FIGS. 4A through 4E, three seeds (SEED 1, SEED 2 and SEED 3) are extracted from a read. Then, it is assumed that mapping positions of the seeds in the target genome sequence are respectively set to 2,001^{th} bp, 2,101^{th} bp, and 2,301^{th} bp, a reference value used to determined whether global alignment on each seed is performed is set to 128 bp, a length of each seed is set to 30 bp, and global alignments on SEED 1, SEED 2 and SEED 3 are sequentially performed so as to align the read. First, in case of the SEED 1, since there is no global alignment performed in advance, global alignment on a read in a target sequence at the corresponding position (2,001 bp) is normally performed. In case of SEED 2 to be subsequently mapped, however, whether the global alignment is performed depends on a repeat judgment region calculated from a mapping position of SEED 2.

As shown FIG. 4A, first, the repeat judgment region may be defined as a region in which a difference in distance from a 1^{st} mapping position of the seed is spaced apart by a reference value. That is, according to the exemplary embodiment shown) FIG. 4A, the repeat judgment region of SEED 2 is a region corresponding to 128 base pairs upstream and downstream of the 210 base pair which is a 1^{st} mapping position of SEED 2 (that is, a region indicated by grey in the drawing). In this case, since the global alignment on SEED 1 is performed in the repeat judgment region, the global alignment is not performed at the mapping position of SEED 2.

Next, as shown in FIG. 4B, the repeat judgment region may be defined as a region in which a difference in distance from the last mapping position of the seed is spaced apart by the reference value. That is, according to the exemplary embodiment shown in FIG. 4B, the repeat judgment region of SEED 2 is a region corresponding to 128 base pairs upstream and downstream of the 2130^{th} base pair which is the last mapping position of SEED 2 (that is, a region indicated by grey in the drawing). In this case, since the mapping position (2001^{st} bp) of SEED 1 on which the global alignment is pre-performed falls out of the repeat judgment region, the global alignment is formed at the mapping position of SEED 2.

FIG. 4C shows one exemplary embodiment in which the exemplary embodiments shown in FIGS. 4A and 4B are generalized to set the repeat judgment region as a region in which a difference in distance from a k^{th} mapping position of the seed (1≦k≦N, wherein N represents a length of the seed) is spaced apart by the reference value. In this case, whether the global alignment on SEED 2 is performed depends on the value k.

Meanwhile, as shown in FIG. 4D, the repeat judgment region may be formed to include a region spanning from a position spaced apart from the 1^{st} mapping position of the seed by the reference value in a forward direction of the target sequence to a position spaced apart from the last mapping position of the seed by the reference value in a backward direction of the target sequence. That is, such a repeat judgment region is substantially identical to the sum of the repeat judgment regions shown in FIGS. 4A and 4B. FIG. 4E shows one exemplary embodiment in which the sum of the repeat judgment regions is generalized to set a repeat judgment region according to Expression 1.

As described above, when global alignment on one seed is performed, the global alignment on seeds around the one seed is not performed. The reasons are as follows. Since the respective seeds that are candidates for global alignment are derived from one read, the fact that the respective seeds are mapped in similar sections in the target genome sequence means that the corresponding read may be mapped in the corresponding section with high probability. Therefore, it is possible to map the read at the corresponding position by performing the global alignment on one of the seeds mapped in the corresponding section. On the contrary, from the results of the global alignment on one of the seeds mapped in the similar sections, a case in which the read is not mapped means that another seed may not also be mapped in the corresponding section with high probability. Therefore, according to the exemplary embodiments of the present disclosure, the repeat judgment region may be set for the respective seeds, and the global alignment may not be repeatedly performed when the global alignment is pre-performed in the corresponding region, thereby effectively reducing the cycles of the global alignment for which a large amount of time is required. More particularly, it is revealed that there is a difference in alignment rage ranging from approximately 30 to 35 times between algorithms that use and not use the global alignment method according to the present disclosure.

Meanwhile, the reference value may be set in proportion to the length of the read. More particularly, the reference value may be set to 100% to 170% of the length of the read. The reference value is set in proportion to the length of the read because the global alignment is performed using the read. That is, since the section spaced apart from the mapping position by the length of the read is a section in which the global alignment is pre-performed, there is no need to repeatedly perform the global alignment. Also, the reference value expands to 170% of the length of the read because errors may occur in the read or the target genome sequence due to insertion or deletion of the genome sequence. Accordingly, the reference value is determined in consideration of this fact. When the reference value is set to vary in proportion to the length of the read as described above, the mapping accuracy may be maintained while improving an alignment rate of the algorithm for aligning a genome sequence, as described above.

FIG. 5 is a block diagram showing a system 500 for aligning a genome sequence according to one exemplary embodiment of the present disclosure. The system 500 for aligning a genome sequence according to one exemplary embodiment of the present disclosure is a device for performing the above-described method of aligning a genome sequence, and includes a seed production unit 502, a mapping position calculation unit 504 and a global alignment unit 506.

The seed production unit 502 produces a plurality of seeds from a read obtained in a genome sequencer. As described above, a method of producing seeds from a read at the seed production unit 502 is not particularly limited. For example, various algorithms of extracting seeds from some or all of the read may be used without limitation.

The mapping position calculation unit 504 selects one of the plurality of seeds produced at the seed production unit 502, and calculates a mapping position of the selected seed with respect to the target sequence.

The global alignment unit 506 calculates a repeat judgment region for the selected seed from the mapping position calculated at the mapping position calculation unit 504, determines whether global alignment is pre-performed in the calculated repeat judgment region, and perform global alignment on the selected read at the calculated mapping position when the global alignment is not pre-performed at the global alignment unit. In this case, detailed description of the calculation of the repeat judgment region is as described above, and thus is omitted for clarity.

Meanwhile, the exemplary embodiments of the present disclosure may include a computer-readable recording medium equipped with programs for executing the methods described herein on a computer. The computer-readable recording medium may include program commands, local data files, local data structures, etc., which may be used alone or in combination. The computer-readable recording medium may be particularly designed or constructed for the purpose of the present disclosure, or may also be known and used by persons of ordinary skill in computer software-related art. Examples of the computer-readable recording medium may include magnetic media such as hard disks, floppy disks and magnetic tapes, optical recording media such as CD-ROMs and DVDs, magneto-optical media such as floppy disks, and hardware devices, such as ROMs, RAMs and flash memories, which are particularly constructed to store and execute the program commands. Examples of the program commands may include high-level language codes capable of being executed by a computer using an interpreter, as well as machine codes such as those constructed by compilers.

According to the exemplary embodiments of the present disclosure, since positions at which the global alignment is pre-performed are memorized upon alignment of a genome sequence not to perform the global alignment around such positions, the cycle number of global alignments at which a large amount of time is required in a process of aligning a genome sequence can be reduced, thereby drastically reducing a time required to align a genome sequence.

As described above, a size of the repeat judgment region in which the global alignment is not repeatedly performed can be set in proportion to the length of the read, thereby reducing a time required to align a genome sequence and maintaining alignment accuracy of the genome sequence.

It will be apparent to those skilled in the art that various modifications can be made to the above-described exemplary embodiments of the present disclosure without departing from the spirit or scope of the present disclosure. Thus, it is intended that the present disclosure covers all such modifications provided they come within the scope of the appended claims and their equivalents.

What is claimed is:

1. A system, intended for use in aligning a genome sequence, the system comprising a computer executing program commands and thereby implementing:
a mapping position calculation unit configured to:
select a seed, of a plurality of seeds produced from a read; and
calculate a mapping position, of the selected seed, in a target sequence; and
a global alignment unit configured to:
calculate a repeat judgment region, for selected seed, from the calculated mapping position;
make a determination as to whether global alignment is pre-performed in the calculated repeat judgment region; and
when the determination is negative, perform global alignment on the selected read at the calculated mapping position.

2. The system of claim 1, wherein the global alignment unit is further configured to set the repeat judgment region to include a region to which a distance from a k^{th} mapping position of the selected seed in the target sequence is within a reference value, where k satisfies 1≦k≦N, and where N represents a length of the selected seed.

3. The system of claim 2, wherein the reference value is set in proportion to a length of the read.

4. The system of claim 3, wherein the reference value is set a range of 100% to 170% of the length of the read.

5. The system of claim 1, wherein the global alignment unit is further configured to set the repeat judgment region according to the following expression:
ma−V≦repeat judgment region≦mb+V
where:
ma represents an a^{th} mapping position (1≦a≦N) of the selected seed,
mb represents a b^{th} mapping position (1≦b≦N) of the selected seed,
N represents a length of the selected seed, and
V represents a reference value.

6. The system of claim 5, wherein the reference value is set in proportion to the length of the read.

7. The system of claim 6, wherein the reference value is set within a range of 100% to 170% of the length of the read.

8. The system of claim 1, wherein the global alignment unit is further configured to determine that the global alignment is performed in the repeat judgment region when the mapping position of the selected seed, in which the global alignment is pre-performed, is included in the repeat judgment region.

9. A method, intended for use in aligning a genome sequence, the method comprising:
using a mapping position calculation unit to:
select a seed, of a plurality of seeds produced from a read; and
calculate a mapping position, of the selected seed, in a target sequence;
using a global alignment unit to:
calculate a repeat judgment region, for the selected seed, from the calculated mapping position,
make a determination as to whether global alignment is pre-performed in the calculated repeat judgment region; and
when the determination is negative, perform global alignment on the selected read at the calculated mapping position.

10. The method of claim 9, wherein the repeat judgment region includes a region to which a distance from a k^{th} mapping position of the selected seed in the target sequence is within a reference value, where k satisfies 1≦k≦N, and where N represents a length of the selected seed.

11. The method of claim 10, wherein the reference value is set ire proportion to a length of the read.

12. The method of claim 11, wherein the reference value is set within a range of 100% to 170% of the length of the read.

13. The method of claim 9, wherein the repeat judgment region is set according to the following expression:
ma−V≦repeat judgment region≦mb+V
where:
ma represents an a^{th} mapping position (1≦a≦N) of the selected seed.
mb represents a b^{th} mapping position (1≦b≦N) of the selected seed,
N represents a length of the selected seed, and
V represents a reference value.

14. The method of claim 13, where the reference value is set in proportion to a length of the read.

15. The method of claim 14, wherein the reference value is set within a range of 100% to 170% of the length of the read.

16. The method of claim 9, wherein the global alignment determined to be performed in the repeat judgment region when the mapping position of the selected seed, in which the global alignment is pre-performed, is included in the repeat judgment region.

17. A device comprising:
one or more processors;
a memory; and
one or more programs,
wherein the one or more programs are configured to be stored in the memory and executed by the one or more processors, and
the program comprises commands to execute operations, comprising:
selecting a seed, of a plurality of seeds produced from a read;
calculating a mapping position, of the selected seed, in a target sequence;
calculating a repeat judgment region, for the selected seed, from the calculated mapping position;
making a determination as to whether global alignment is pre-performed in the calculated repeat judgment region; and
when the determination is negative, performing global alignment on the selected read at the calculated mapping position.
